(19) United States
(12) Patent Application Publication
(10) Pub. No.: US 2017/0140751 A1
(43) Pub. Date: May 18, 2017

(54) METHOD AND DEVICE OF SPEECH RECOGNITION

(71) Applicant: Shenzhen Raisound Technology Co. Ltd., Shenzhen (CN)

(72) Inventors: Shilei HUANG, Shenzhen (CN); Xin WANG, Shenzhen (CN); Yi LIU, Shenzhen (CN); Gang CHENG, Shenzhen (CN)

(73) Assignee: Shenzhen Raisound Technology Co. Ltd.

(21) Appl. No.: 15/161,465

(22) Filed: May 23, 2016

(30) Foreign Application Priority Data
Nov. 17, 2015 (CN) 201510793497.1

(51) Int. Cl. G10L 15/08

(52) U.S. Cl. CPC G10L 15/08

(57) ABSTRACT

A method of speech recognition includes the following steps: receiving a first speech input, and converting the first speech input into a first digital signal; transmitting the first digital signal to a cloud server; receiving a first post-processing result generated according to the first digital signal; receiving a second speech input, and converting the second speech input into a second digital signal; performing a first speech recognition to the second digital signal to obtain a recognition result by using a first speech recognition model; and comparing the first post-processing result with the recognition result to determine a speech recognition result.

### CROSS REFERENCE TO RELATED APPLICATIONS

This application claims priority under 35 U.S.C. §119(b) and 37 CFR 1.55 to Chinese application filed on Nov. 17, 2015, and having serial number CN 201510793497.1, wherein the entirety of said application is incorporated herein by reference.

### FIELD OF THE INVENTION

The present invention relates to a method and a device of speech recognition, and more particularly relates to a speech recognition method based on cloud speech recognition and a corresponding device.

### BACKGROUND OF THE INVENTION

Mobile equipments, especially smart phones, have multiple interaction modes, among which a speech interaction mainly based on speech recognition technologies is one of the most important interaction modes of the mobile equipments.

The speech recognition technology or so-called automatic speech recognition (ASR), is used to covert contents of speech into a computer-readable input, such as a button, binary encoding or a character sequence, and perform a corresponding operation.

A most popular framework of speech recognition is based on Hidden Markov Model (HMM). There are various implementations of HMM ASR systems, such as discrete distribution HMM (DHMM), semi-continuous distribution HMM (SCHMM), and continuous distribution HMM (CDHMM). Normally, in a speech recognition system, an acoustic model (AM) and a language model (LM) are required.

For mobile equipments, a speech recognition task requires a large amount of computation, especially, some information query tasks are based on large vocabulary continuous speech recognition (LVCSR).

A possible solution is to perform speech recognition on a cloud server. A speech segment or an acoustic feature vector is uploaded to the cloud server (i.e. server side) through a network, the speech recognition is performed on the server side, and then the result of the speech recognition is transmitted to the mobile terminal. With the cooperation of the cloud server, the amount of calculation on the mobile terminal is reduced; in addition, the main calculation is concentrated on the cloud server, thus speech recognition algorithms that is more complex with better performance can be applied, and it is convenient to combine with other application services. However, such speech recognition of totally operating on the cloud server has a disadvantage of a relatively long transmitting time delay. After finishing recording a speech on the terminal, processing the speech on the cloud server, obtaining the relative information generated by the speech recognition processing of the cloud server on the terminal, and performing corresponding operation, the time delay during these processes is usually hundreds of millisecond to seconds, which is relatively poor in user experience.

### SUMMARY OF THE INVENTION

Accordingly, it is necessary to provide a method of speech recognition for reducing delay.

A method of speech recognition includes the following steps: receiving a first speech input, and converting the first speech input into a first digital signal; transmitting the first digital signal to a cloud server; receiving a first post-processing result generated according to the first digital signal; receiving a second speech input, and converting the second speech input into a second digital signal; performing a first speech recognition to the second digital signal to obtain a recognition result by using a first speech recognition model; and comparing the first post-processing result with the recognition result to determine a speech recognition result.

Another method of speech recognition is also provided, which includes the following steps: receiving a first digital signal generated according to a first speech input; performing a second speech recognition to the first digital signal by using a second speech recognition model to obtain a recognition result; performing a post-processing according to the recognition result by using a post-processing model, and obtaining a first post-processing result; and outputting the first post-processing result.

In addition, a corresponding speech recognition device is also provided, which includes: at least one memory storing computer-readable instructions; and at least one processor that executes the instructions to provide; a speech conversion module configured to receive a speech input, and convert the received speech input into a corresponding digital signal; a communication module configured to transmit the digital signal to a cloud server and receive a post-processing result generated according to the digital signal; a speech recognition module configured to perform a first speech recognition according to the digital signal to obtain a recognition result; and a determining module configured to compare the post-processing result with the recognition result to generate a comparison result.

Another speech recognition device is also provided, which includes: at least one memory storing computer-readable instructions; and at least one processor that executes the instructions to provide; a communication module configured to receive a corresponding digital signal converted according to a received speech input; a speech recognition module configured to perform a second speech recognition to the digital signal by using a second speech recognition model to obtain a recognition result; and a post-processing module configured to perform a post-processing according to the recognition result by using a post-processing model, and obtain a post-processing result, wherein the communication module is further configured to output the post-processing result.

According to the embodiments of the method and the speech recognition device, a relatively accurate recognition result on the server is used to perform the post-processing, and it is compared with the recognition result with less delay on the mobile terminal, so as to instruct the operation to be performed, which avoids the delay of the operation indication generated by the server recognition, reduces the delay without losing too much accuracy, and improves the user experience.

### BRIEF DESCRIPTION OF THE DRAWINGS

In order to describe the manner in which the above-recited and other advantages and features is capable of be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and details using of the accompanying drawings in which:

FIG. 1 is a block diagram of a speech recognition device in accordance with one embodiment;

FIG. 2 is a flow chart of a method of speech recognition in accordance with the embodiment; and

FIG. 3 is a sequence chart of the device and the method of speech recognition in accordance with the embodiment.

### DETAILED DESCRIPTION OF THE EMBODIMENTS

Various embodiments are now described with reference to the drawings, wherein like reference numerals are used to refer to like elements throughout. In the following description, for purposes of explanation, numerous specific details are set forth in order to provide a thorough understanding of one or more aspects. It may be evident, however, that the various embodiments may be practiced without these specific details. In other instances, well-known structures and devices are shown in block diagram form in order to facilitate describing these embodiments.

As used in this application, the terms “component, “module,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Any reference to memory, storage, database, or other medium as used herein can include nonvolatile and/or volatile memory. Suitable nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

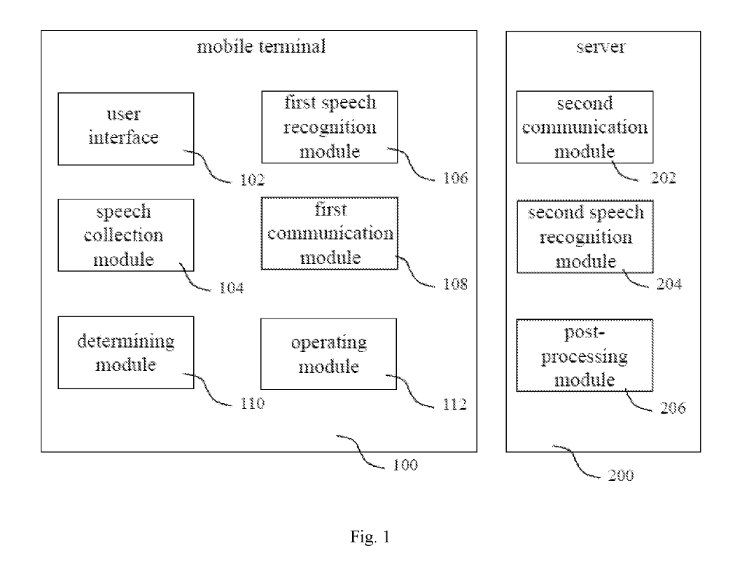

Referring to FIG. 1, FIG. 1 is a block diagram of a speech recognition device in accordance with one embodiment. In the illustrated embodiment, a speech recognition system receives a speech input by a mobile terminal 100, after the speech input is processed on the mobile terminal 100 itself and a server (cloud server) 200, an operation corresponding to the speech input is performed on the mobile terminal 100.

The mobile terminal 100 includes at least one memory storing computer-readable instructions; and at least one processor that executes the instructions to provide: a user interface 102, a speech conversion module 104, a first speech recognition module 106, a first communication module 108, a determining module 110, and an operating module 112.

The user interface 102 is configured to provide an interface for interaction between the mobile terminal 100 and a user. The user interface 102 includes display information, operation prompt, and input interface, etc. The user interface 102 is further configured to receive relative operations of the user based on the output interface. In one embodiment, the user interface 102 is a GUI, which is capable of displaying or broadcasting information such as operation interfaces and contents to the user through a screen and/or a loudspeaker, and receiving user inputs via a keyboard, a touch screen, a network, or a microphone.

The speech conversion module 104 is configured to receive the speech from a speech recorder, and convert the received speech in to a corresponding digital signal. In some embodiments, the speech conversion module 104 is further configured to pick up acoustic features for the speech recognition. Alternatively, the speech conversion module 104 applies waveform signals of PCM encoding.

Furthermore, in alternative embodiments, the speech conversion module 104 is further configured to convert the signal of PCM encoding into an acoustic feature vector, which can be directly used by the speech recognition. An example of such acoustic feature vector includes MFCC (Mel-Frequency Cepstrum Coefficients) features that generally used in the speech recognition. After the speech conversion module 104 converts the acoustic feature vector, the converted acoustic feature vector can be output in a later data transmission. One of the advantages of applying acoustic feature vector transmission is that the amount of data to be transmitted can be reduced.

The first speech recognition module 106 is configured to perform a first speech recognition according to the digital signal converted by the speech conversion module 104. According to one embodiment, in order to reduce the processing data quantity and the processing load of the speech recognition performed by the mobile terminal 100, the speech recognition module 106 is a relatively simple speech recognizer. Comparing the speech recognition of the speech recognition module 106 to that of the cloud server 200, relatively simple model and algorithm are used, which can obtain enough information with an extremely low system resource consumption. According to an alternative embodiment, the speech recognition module 106 performs the first speech recognition based on a phoneme based acoustic model and phoneme based language model.

The first communication module 108 is configured to transmit the digital signal converted by the speech conversion module 104 to the server 200. In an alternative embodiment, the first communication module 108 is further configured to perform an interchange of other information between the mobile terminal 100 and the server 200, including transmitting information such as a speech, an acoustic feature and a time stamp mark to the server, and receive information to be transmitted to the mobile terminal 100 from the cloud server 200, including a speech recognition result, time information and a score of the recognition result. In an embodiment, the first communication module 108 is further configured to receive a post-processing result generated according to the digital signal by the server 200.

The determining module 100 is configured to compare the post-processing result with the recognition result obtained by performing the first speech recognition by the first speech recognition module 106, and obtain a comparison result.

In an alternative embodiment, the server 200 can provide one or a plurality of post-processing results according to the digital signal. When a user speech command is received and an operation corresponding to the user speech command is performed by the operating module 112, if there is only one possible result of the post-processing results obtained according to the user speech, the result is then directly transmitted to the operating module 112. However, if the plurality of possible post-processing results are obtained after the post-processing of the server 200, it is necessary to select several most possible results from the recognition results obtained by performing the first speech recognition by the first speech recognition module 106 to the operating module 112.

An example is as followed, according to the received digital signal, the server 200 outputs two possible post-processing results of “what's the weather today” and “what's the weather tomorrow”. If the first speech recognition module 106 is a phoneme based recognition model, and the recognition result is “w of z dh e w e dh er t e m o”, then the determining module 110 may select the post-processing result “what's the weather tomorrow” that most similar to the recognition result obtained by performing the first speech recognition by the first speech recognition module 106 as the comparison result.

The operating module 112 is configured to perform a corresponding operation according to the comparison result of the determining module 110. In an illustrated embodiment, the operating module 112 perform the corresponding operation to the speech recognition result, characteristic in being capable of processing several continuous recognition results. That is to say, when the server 200 outputs a post-processing result ASRO_X1 according to a speech interaction process, and the post-processing result ASRO_X1 is compared and selected as the comparison result by the determining module 110, and the operating module 112 performs a corresponding respond ACT_X1. In such process, if the server 200 continues to output another post-processing result ASRO_X2 of this speech interaction process, and the post-processing result ASRO_X2 is compared and selected as the comparison result by the determining module 110, then the operating module 112 has to smoothly transit the respond ACT_X1 to a respond ACT_X2 corresponding to the post-processing result ASRO_X2.

An example of the operating module 112 is shown. In an alternative map application, when the user inputs a point of interest (POI), after the post-processing by the server 200 and the comparing by the determining module 110, the first output recognition result is “South Technology Tower”. Meanwhile, the operating module 112 points out the “South Technology Tower”, and a focus (center point of a view) shown on the user interface 102 is moved from a current location (L0) to the “South Technology Tower” (L1). During the moving process, if the output recognition result changes to “South Technology University” after a further post-processing of the server 200 and the comparing of the determining module 110, then the operating module 112 and the user interface 102 change to point out the “South Technology University” (L2), and the focus (center point of a view) shown on the user interface 102 is moved from a current location (may be at any point L3 between L0 to L1) to the “South Technology University” (L2). Furthermore, if the recognition results further renew to a new location, the focus has to move again unless the user take a next operation.

The server 200 includes a second commutation module 202, a second speech recognition module 204, and a post-processing module 206.

The second communication module 202 is configured to receive the corresponding digital signal converted according to the received speech input by the first communication module 108 of the mobile terminal 100.

Alternatively, the first communication module 108 can communicate with the second communication module 202 by means of a feasible data communication protocol.

The second speech recognition module 204 is configured to perform a second speech recognition to the digital signal received by the second communication module 202 by using a second speech recognition model.

According to an alternative embodiment, the second speech recognition module 204 may be a recognizer with a complex acoustic and language model and a complex algorithm. The second speech recognition model used by the second speech recognition module 204 to perform speech recognition is more accurate than the speech recognition model used by the first speech recognition module 106 of the mobile terminal 100, and thus the second speech recognition model requires a relatively large amount of calculation. For instance, the second speech recognition model may be a phoneme based tri-phone acoustic model and a word based N-gram (usually 3-gram) language model, so as to achieve an LVCSR (large vocabulary continuous speech recognition) recognizer by the second speech recognition module 204.

The second speech recognition module 204 can perform the second speech recognition continuously. Since the first and second communication modules start to communicate a speech or an acoustic feature, the second speech recognition module 204 can continuously perform the second speech recognition to a short speech or a corresponding acoustic feature vector (a frame of speech or a plurality of acoustic feature vectors) each inputted in a fixed time interval. Generally, the fixed time interval is equal to a duration of the short speech. For instance, if a first frame of speech reaches the second speech recognition module 204 at time t1, and passes a preset delay dt1 (such as 0.3 seconds), the second speech recognition module 204 outputs the result of its second speech recognition. The output result is the recognition result obtained by performing the second speech recognition to the received speech in a time prior from t1 to the outputting of the result (or even a shorter time prior), for there is a processing delay. Generally, the output result is considered as a partial result. Afterward, because speeches are continuously inputted by the first and second communication modules, and the partial result obtained by performing the second speech recognition can be continuously renewed. An exemplary input and output processes of the second speech recognition module 204 are shown as followed:

| contents received by the second | outputs of the second speech |
|---|---|
| communication module | recognition module (symbols) |
| a first frame of a speech | N/A |
| “what's” | N/A |
| “what's the” | what's |
| “what's the weather” | what's the |
| “what's the weather today” | what's the weather |

As described above, the speech conversion module 104 may be configured to continuously receive speeches and convert the speeches into digital signals, wherein the process of converting the second speech input into the second digital signal, the process of performing the second speech recognition to the first digital signal by the server 200, and the process of post-processing and generating the first post-processing result can be performed simultaneously.

The post-processing module 206 is configured to perform the post-processing according to the recognition result obtained by performing the second speech recognition to the digital signal by the second speech recognition module 204 by using a post-processing model, and obtain the post-processing result. The post-processing module 206 performs the post-processing based on the post-processing model, an example of which is using a language model more complex than the language model of the second speech recognition model as the post-processing model, such as a word based 6-gram language model. Another example is in recognition of the POI, the post-processing model includes a POI list of a location, such as ten thousands POI lists in a district of a city. As an example, when the inputted recognition result of the second speech recognition module 204 is “what's the weather”, the post-processing result of the post-processing module 206 is “what's the weather today”.

An output of the second speech recognition module 204 is a sequence. In the sequence, each item represents a recognition result symbol (here refers to the phoneme) at a corresponding time. Each item may include the plurality of hypotheses, and each hypothesis at least includes “time”, “symbol (phoneme)”, and “score”. Therefore, the outputs of the second speech recognition module 204 are a plurality of hypotheses, each having a corresponding score, wherein the larger score represents a higher probability. For instance, for the first item of a best sequence, there are three hypotheses: “0, n, 0.9”, “0, m, 0.8” and “0, 1, 0.5”. To be concerned, each item may have a difference in the sum of the possible hypotheses. For simplicity, sometimes only the best or first hypothesis of items in sequence is considered, such as the initial “n”.

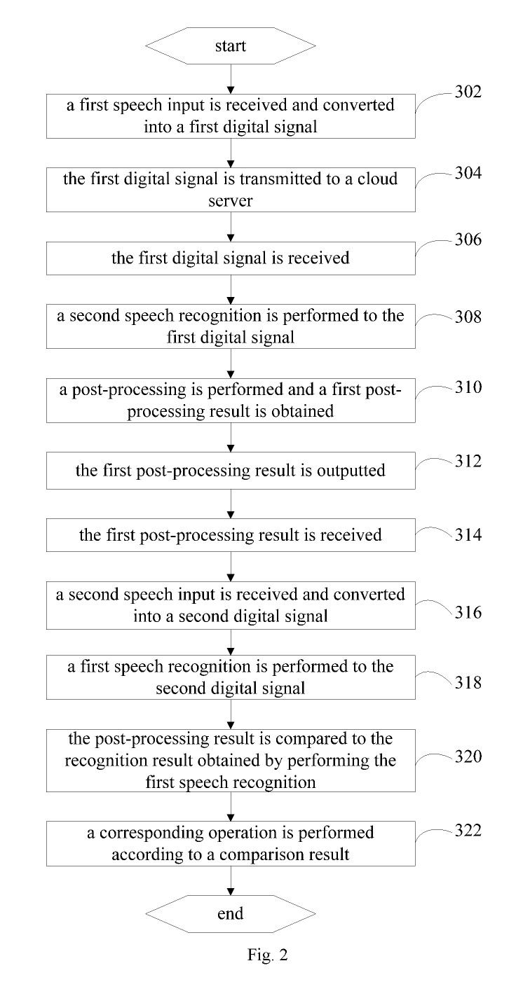

FIG. 2 shows a flow chart of a method of speech recognition in accordance with the embodiment, the method of speech recognition is described in combination with the speech recognition device shown in FIG. 1.

In step 302, the first speech input is received, and the received first speech input is converted into the first digital signal.

Specifically, the user starts the speech conversion module 104 through the user interface 102 of the mobile terminal 100, so as to make the speech conversion module 104 begin receiving the speech input of the user from a speech recorder. The speech conversion module 104 then converts the received first speech input of the user into the first digital signal.

In step 304, the first digital signal is transmitted to the cloud server.

Specifically, the first digital signal generated by the speech conversion module 104 is output by the first communication module 108, and received by the second communication module 202 at the server 200.

In step 306, the first digital signal is received.

Specifically, at the server 200, the first digital signal generated according to the received first speech input and transmitted by the first communication module 108 of the mobile terminal 100 is received by the second communication module 202.

In step 308, the second speech recognition is performed to the first digital signal by using the second speech recognition model.

Specifically, the second speech recognition module 204 of the server 200 performs the second speech recognition to the first digital signal by using the second speech recognition model. As described above, the second speech recognition model for the second speech recognition used by the second speech recognition module 204 is more complex and more advanced than the first speech recognition model for the first speech recognition used by the first speech recognition module 106 of the mobile terminal 100, requiring the larger data amount of calculation.

In step 310, the post-processing is performed according to the recognition result obtained by performing the second speech recognition to the first digital signal by using the post-processing model, and the first post-processing result is obtained.

Specifically, the recognition result obtained by performing the second speech recognition by the second speech recognition module 204 is post-processed by the post-processing module 206 by using the post-processing model, and the first post-processing result is obtained. As described above, the language model of the post-processing model is more complex than the language model of the second speech recognition.

In step 312, the first post-processing result is output.

Specifically, the first post-processing result obtained by performing the post-processing of the post-processing module 206 is transmitted to the second communication module 202, and transmitted to the first communication module 108 of the mobile terminal by the second communication module 202.

In step 314, the post-processing result generated according to the first digital signal is received.

Specifically, at the mobile terminal 100, the first communication module 108 receives the first post-processing result generated by the post-processing module 206 from the second communication module 202 of the server 200.

In step 316, the second speech input is received, and the received second speech input is converted into the second digital signal.

Specifically, similar to the receiving of the first speech input and the converting of the first digital signal described above, the speech conversion module 104 receives the second speech input further inputted by the user, and converts the second speech input into the corresponding second digital signal. Understandably, such process of converting the second speech input into the second digital signal performed in step 316 may be started immediately after converting the first speech input into the first digital signal. Therefore, the process of converting the second speech input into the second digital signal, the process of performing the second speech recognition to the first digital signal by the server, and the process of post-processing and generating the first post-processing result can be performed simultaneously.

In step 318, the first speech recognition is performed to the second digital signal by using the first speech recognition model.

Specifically, the first speech recognition module 106 of the mobile terminal 100 performs the first speech recognition to the second digital signal by using the first speech recognition model. The first speech recognition model is a relatively simple speech recognition model; in order to reduce the data processing load at the mobile terminal, the first speech recognition model is not complex.

Similar to the above description, because of the continuity of the speech inputs, the process of performing the first speech recognition to the second digital signal in step 318 may be started immediately after converting the second speech input into the second digital signal. Therefore, the process of performing the first speech recognition to the second digital signal, the process of performing the second speech recognition to the first digital signal by the server, and the process of post-processing and generating the first post-processing result can be performed simultaneously.

In step 320, the first post-processing result is compared with the recognition result obtained by performing the first speech recognition to the second digital signal.

Specifically, the determining module 110 of the mobile terminal 100 compares the received the plurality of possible first post-processing results with the recognition result obtained by performing the first speech recognition to the second digital signal, and selects the post-processing result which is the most similar to the recognition result obtained by performing the first speech recognition to the second digital signal from the plurality of possible first post-processing results as the comparison result.

In step 322, the corresponding operation is performed according to the comparison result.

Specifically, the operating module 112 performs the corresponding operation, such as input, calculation, search, location or navigation according to the comparison result obtained by the comparing of the determining module 110.

Understandably, each step of step 302 to step 322 shown in FIG. 2 may be performed at the mobile terminal 100 or the server 200, although these steps are illustrated in one embodiment for simplification, it is not necessary to include each step at the mobile terminal 100 or the server 200 in other embodiments. Any separation and combination of the steps mentioned above shall be considered as the embodiment of the invention, as long as it can realize the purpose of the invention.

In the device and the method of speech recognition according to the embodiments of the present disclosure, comparing to performing the recognition at the cloud server and instructing the mobile terminal to perform operations, delay is greatly reduced, and the user experience is improved. Generally, the speech recognition module with complex speech recognition model is configured at the cloud server, the recognition result of the speech recognition is transmitted to the mobile application via the communication module, and the corresponding operation is performed. The possible delays between finishing inputting speech and beginning to perform the corresponding action include but is not limited to: a voice activity detection (VAD) delay (such as 200 ms), an acoustic feature receiving delay (such as 25 ms), a communication delay from the mobile terminal to the cloud server (such as 500 ms), a processing delay of speech recognition at the cloud server (such as 200 ms), a communication delay of returning the recognition result from the cloud server to the mobile terminal (such as 500 ms), and a responding delay of the operation at the mobile terminal (such as 50 ms). Although a relatively accurate recognition result may be obtained by using the cloud server and less computation requirements for the mobile terminal, the total delay is over 1.5 seconds, which greatly affects the user experience.

According to the post-processing module and the post-processing process in the embodiments described above, a result with some possibility is added to the end of recognition result of module 204, such as adding four syllables (corresponding to 1 second to 1.5 seconds) to the original recognition result, which may show a very short delay from the view of the user considering the time spam between the end of user's speech and the action of mobile application. When the user finishes inputting speech (such as an effective speech of 3 seconds), because of existing delay, the second speech recognition module at the cloud server has approximately processed the speech for 1.5 seconds (corresponding to the 1.5 second delay). However, since the first speech recognition module already completes processing the subsequent speech input of the first speech input, the user interface can act according to the content of speech with 3 seconds long (corresponding to the post-processing of the four syllables, 1.5 seconds), which appears a very short delay on the user experience.

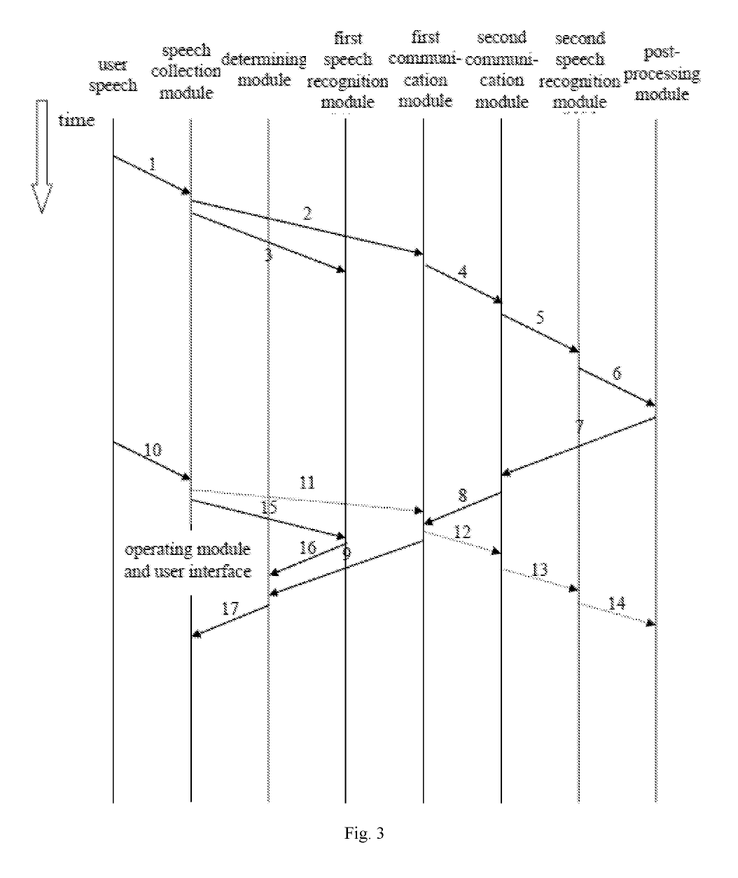

FIG. 3 shows a sequence chart of the device and the method of speech recognition in accordance with the embodiment. The sequence of the embodiment is described in combination with an exemplary application scene as followed.

In the illustrated embodiment, there is a map application on the mobile terminal 100, and some location-based information is shown on the user interface 102. In such an application, after the user inputs a speech, the mobile terminal moves the focus to the location inputted by the user, and the corresponding information will be provided after the user confirms the location. For English speech input, the user actually inputs six syllables of “South Technology University”, and the effective speech is about 1.9 seconds.

Suppose the effective speech input of the user starts from t₀, and the speech collection module 104 begins receiving the speech. In an embodiment, the time length of each frame of the speech is 25 ms, and the frame shift is 10 ms, that is to say, from t₀+25 ms, there is one frame of speech recorded completely every 10 ms. Suppose an elapsed time of the speech conversion module 104 to receive the acoustic feature is 5 ms, then from t₀+30 ms, there is one frame of speech transmitted simultaneously to the first speech recognition module 106 and the first communication module 108 every 10 ms.

At the first speech recognition module 106, as described above, the phoneme based bi-phone acoustic model and the phoneme based 3-gram language model may be used. After 30 ms since the beginning time t₀ of the inputting of the effective speech, the acoustic feature starts being inputted to the first speech recognition module 106. Because of the inherent processing delay of the first speech recognition module 106, although the first speech recognition module 106 starts processing the acoustic feature vector from t₀+30 ms, after a short time delay, such as 10 ms. The first speech recognition is performed to the first digital signal at t₀+40 ms, and the recognition result is obtained, then the first speech recognition module 106 can output the recognition result.

However, considering the integrity of the speech recognition, i.e. the output should consist of acoustic units (phoneme in the illustrated embodiment, the initial of which is “n” corresponding to the “South Technology University”). Therefore, the first speech recognition module 106 starts providing the first speech recognition output only when it has received enough acoustic feature vectors that may represent at least one acoustic unit (phoneme in the illustrated embodiment). In the illustrated embodiment, for instance, at least four frames of speech is enough to output the one speech recognition unit, thus the first speech recognition module 106 start outputting the result of the first speech recognition at t₀+40 ms+(4−1)*10 ms=t₀+70 ms.

It should be noted that the waveform corresponding to the four frames of speech processed by the first speech recognition module 106 ends at t₀+25 ms+(4−1)*10 ms=t₀+55 ms, and there exist an actual delay of about 15 ms (such as considering the case that the system is busy and the CPU for the first speech recognition module 106 is not able to process timely) before the result of the first speech recognition output by the first speech recognition module 106 at t₀+70 ms.

According to the embodiment of the present disclosure, the output of the second speech recognition module 204 is a sequence. In the sequence, each item represents a recognition result symbol (here refers to the phoneme) at a corresponding time. Each item may include a plurality of hypotheses, and each hypothesis at least includes “time”, “symbol (phoneme)”, and “score”, Therefore, the second speech recognition module 204 outputs the plurality of hypotheses, each having a corresponding score, wherein the larger score represents a higher probability. For instance, with regard to an initial of a best hypothesis, there are three symbols of “0, n, 0.9”, “0, m, 0.8” and “0, 1, 0.5”. To be concerned, each symbol may have a difference in the sum of the possible hypotheses. For simplicity, sometimes only the best hypothesis sequence is considered, such as the initial “n”.

For example, at t₀+2000 ms, the second speech recognition module 204 outputs a best hypothesis sequence of “South Technology University”, while the phoneme corresponding to the actual speech input should be “s aw dh t eh k n oh l ax jhiy y uw n ih v er s ih t iy” (it is understandable that there may be errors in the best hypothesis).

As described above, the second speech recognition module 204 may perform the second speech recognition by using the phoneme based tri-phone acoustic model and a word based 5-gram language model.

When the second speech recognition module 204 receives the acoustic feature, the delay is relatively large, therefore, in a typical case, the second speech recognition module 204 starts processing the speech at t₀+530 ms. After a short time delay, such as 10 ms, the second speech recognition module 204 starts outputting the result of the second speech recognition at t₀+540 ms.

Although the processing delay of the second speech recognition module 204 is the same as that of the first speech recognition module 106, which is 10 ms, the second speech recognition module 204 can obtain relative accurate results because the CPU of the server 200 is more powerful than that of the mobile terminal 100. In practical system, the second speech recognition module 204 can perform speech recognition more complicated tasks than those of the mobile terminal 100.

Similarly, considering the integrity of the speech recognition, i.e. the output should include an integral speech recognition acoustic unit (phoneme), therefore, the second speech recognition module 204 starts providing the second speech recognition output only when it has received enough acoustic feature vectors that may be capable of outputting one speech recognition unit, such as at least four frames of speech, i.e. t₀+540 ms+(4−1)*10 ms=t₀+570 ms. The four frames of speech are processed by the second speech recognition module 204 here, and the corresponding waveform has ended at t₀+25 ms+(4−1)*10 ms=t₀+55 ms. Correspondingly, the actual delay of the second speech recognition module 204 is about 515 ms. Furthermore, considering the integrity word to be output by the second speech recognition module 204, more waiting frames are required, and a new delay may be inserted.

Accordingly, suppose the second speech recognition module 204 outputs a “South” at t0+1100 ms, a “South Technology” at t0+1800 ms, and a “South Technology University” at t0+2600 ms, the corresponding actual speech inputs are the “South” at t0+700 ms, the “South Technology” at t0+1400 ms, and the “South Technology University” at t0+2000 ms.

As described above, the output of the second speech recognition module 204 may be a triad of “time, symbol (word or phrase in the illustrated embodiment), score”. The time represents the ending time corresponding to the symbol, and the larger score represents a higher probability. For instance, a “700 ms, South, 0.9” herein represents the speech last from beginning to 700 ms, the speech content may be “South”, and the score is 0.9.

For example, suppose the post-processing model used by the post-processing module 206 is all of the POI lists in the area, and the POIs are sorted according to a popularity (i.e. a POI of more query times is sorted by top).

The output of the post-processing module 206 may also be a triad of “time, symbol (word or phrase in the illustrated embodiment), score”, the meaning of which is similar to the above output of the second speech recognition module 204, with a only difference of contents. For instance, corresponding to the output “700 ms, South, 0.9” of the second speech recognition module 204, the output of the post-processing module 206 is “700 ms, South Aero Tower, 0.5”.

At t₀+1100 ms, the post-processing module 206 receives the output “South” of the second speech recognition module 204, and looks up the hundreds of POIs with the beginning of “South” according to the post-processing model, including a “South Aero Tower”, “South Technology University”, “South Technology Tower”, “South Art Center” and so on, and outputs three front POIs the order of the score from high to low, namely “700 ms, South Aero Tower, 0.5”, “700 ms, South Technology University, 0.45”, and “700 ms, South Technology Tower, 0.4” to the second communication module 202. Obviously, the number of the outputs herein can be any number greater than zero.

At t₀+1800 ms, the post-processing module 206 receives the output “South Technology” of the second speech recognition module 204, and finds out ten POIs beginning with “South Technology” according to the post-processing model, including “South Technology University”, “South Technology Tower”, “South Technology University, south gate”, and so on, and outputs first three POIs which have the highest scores, namely “1400 ms, South Technology University, 0.7”, “1400 ms, South Technology Tower, 0.6”, and “1400 ms, South Technology University, south gate, 0.5” to the second communication module 202. Similarly, the number of the outputs herein is not necessary to be three, and the number can be configured.

At t₀+2600 ms, the post-processing module 206 receives the output “South Technology University” of the second speech recognition module 204, and looks up the three POIs with the beginning of “South Technology University” according to the post-processing model, including “South Technology University” and “South Technology University, south gate”, and outputs two results, namely “2000 ms, South Technology University, 0.9” and “2000 ms, South Technology University, south gate, 0.7” to the second communication module 202. Similarly, the number of the outputs herein is not necessary to be two, and the number is able to be set.

Since there is a delay between the second communication module 202 and the first communication model 108. according to the above output of the post-processing module 206, considering the delay (suppose the delay is 200 ms here, while the delay between the first communication module 108 and the second communication model 202 is 500 ms because the upload link and the download the link are asymmetry. i.e. the mobile terminal uploads more data speech or acoustic features than data that recognition results or the post-processing downloaded, while the uplink channel capacity is lower than downlink channel capacity) the following processes are:

At t₀+1300 ms, the determining module 110 receives the outputs of the post-processing module 206, namely “700 ms, South Aero Tower, 0.5”, “700 ms, South Technology University, 0.45”, and “700 ms, South Technology Tower, 0.4”. These outputs of the post-processing module 206 are then converted into phoneme sequences, namely “700 ms, s aw dh t ea r ow t aw ax, 0.5”, “700 ms, s aw dh t eh k n oh l ax jhiy y uw n ih v er s ih t iy, 0.45”, and “700 ms, s aw dh t eh k n oh l ax jhiy t aw ax, 0.4”.

At the moment, the best hypothesis of the first speech recognition module 106 is “s aw dh d eh k n oh l ax jhiy” (please notice that the hypothesis here is not the completely correct result “s aw dh t eh k n oh l ax jhiy”, that is, there is an error that “t” is recognized as “d”). The determining module 110 compares the best hypothesis with the outputs of the post-processing module 206, and finds out the best hypothesis is more similar to the second and the third outputs.

The decision criticized here is Levenshtein distance between two symbol (phoneme) sequences, i.e. the smaller distance value it is, the more similar the two sequences are. In the example above, the distance values between the best hypothesis sequence of module 106 and three hypotheses of module 206 are: 4 (four of the eight symbols of are the same), 1 (seven of the eight symbols of “are the same), and 1 (seven of the eight symbols of are the same). In other embodiments, the plurality of hypotheses of the first speech recognition module 106 may also be considered according to corresponding scores. Alternatively, because the speech inputting of the user has not been finished actually, the operating module 112 may not change the focus.

At t₀+2000 ms, the determining module 110 receives the outputs of the post-processing module 206, namely:

“1400 ms, South Technology University, 0.7”,

“1400 ms, South Technology Tower, 0.6”, and

“1400 ms, South Technology University, south gate, 0.5”.

These outputs of the post-processing module 206 are then converted into phoneme sequences, namely:

“1400 ms, saw dh t eh k n oh l ax jhiy y uw n ih v er s ih t iy, 0.7”,

“1400 ms, s aw dh t eh k n oh l ax jhiy t aw ax, 0.6”, and

“1400 ms, saw dh t eh k n oh l ax jhiy y uw n ih v er s ih t iy saw dh g ey t, 0.5”.

At the moment, the best hypothesis of the first speech recognition module 106 is “s aw dh d eh k n oh l ax jhiy y uw n ih v er s ih t iy”. The determining module 110 compares the best hypothesis with the outputs of the post-processing module 206, and finds out the best hypothesis is more similar to the first and third outputs. The distance values between the best hypothesis sequence of module 106 and three hypotheses of module 206 are: 2 (ten of the twelve symbols of “1400 ms, South Technology University, 0.7” are the same), and 2 (ten of the twelve symbols of “1400 ms, South Technology University, south gate, 0.5” are the same). In other embodiments, the plurality of hypotheses of the first speech recognition module 106 may also be considered according to corresponding scores. The determining module 110 transmits these two options to the operating module 112, meanwhile, the user has finished the speech inputting, the operating module 112 start the operation, moving the focus of the map to the “South Technology University”, and symbolize the possible hypothesis “South Technology University, south gate” at the same time.

At t₀+2800 ms, the determining module 110 receives the outputs of the post-processing module 206, namely:

“2000 ms, South Technology University, 0.9”, and

“2000 ms, South Technology University, south gate, 0.7”.

Since the outputs are the same with those at t0+2000 ms, the operating module 112 performs no more action.

It can be seen that at t₀+2000 ms, which is 100 ms after the user's speech is finished, while actually the second speech recognition module 204 of the cloud server 200 only receives the speech of about 1.5 seconds, but the device and the method of speech recognition according to the present disclosure has already performed the corresponding correct response, so the system response is very fast from the view of the user.

Sometimes, such as at t0+2000 ms, there may be some errors in the post-processing result. In the illustrated embodiment, the best result provided by the determining module 110 is “South Technology Tower”, and the operating module 112 performs the corresponding operation, moving the focus of the map to the “South Technology Tower”. At the moment, the user may sense the error of the recognition, but during the moving of the focus, such as at t0+2800 ms, the best result provided by the determining module 110 is “South Technology University”, and the focus of the map is moved to the “South Technology University” immediately, so the user feels that the system automatically corrects the error.

According to the embodiments of the method and the device of speech recognition, the accurate recognition result on the server is used to perform the post-processing, and compared to the recognition result with less delay on the terminal, so as to instruct the operation to be performed, and thus avoids the delay of the operation indication based on recognition on server side. Generally speaking, the processing reduces the delay without losing too much accuracy, and greatly improves the user experience.

When the integrated unit is implemented in the form of a software functional unit and sold or used as an independent product, the integrated unit may be stored in a computer-readable storage medium. Based on such an understanding, the technical solutions of the present invention essentially, or the part contributing to the prior art, or all or a part of the technical solutions may be implemented in the form of a software product. The software product is stored in a storage medium and includes several instructions for instructing a computer device (which may be a personal computer, a server, or a network device) to perform all or a part of the steps of the methods described in the embodiments of the present invention. The foregoing storage medium includes any medium that can store program code, such as a universal serial bus (USB) flash drive, a removable hard disk, a read-only memory (ROM), a random access memory (RAM), a magnetic disk, or an optical disc.

Although the present disclosure has been described with reference to the embodiments thereof and the best modes for carrying out the present disclosure, it is apparent to those skilled in the art that a variety of modifications and changes may be made without departing from the scope of the present disclosure, which is intended to be defined by the appended claims.

What is claimed is:

1. A method of speech recognition, comprising the following steps:
receiving a first speech input, and converting the first speech input into a first digital signal;
transmitting the first digital signal to a cloud server;
receiving a first post-processing result generated according to the first digital signal;
receiving a second speech input, and converting the second speech input into a second digital signal;
performing a first speech recognition to the second digital signal to obtain a recognition result by using a first speech recognition model; and
comparing the first post-processing result with the recognition result to determine a speech recognition result.

2. The method of claim 1, wherein the first post-processing result comprises a plurality of possible post-processing results, and the comparing the first post-processing result with the recognition result comprises:
comparing the recognition result with the plurality of possible post-processing results; and
determining one post-processing result in the plurality of possible post-processing results which is most similar to the recognition result of the second digital signal recognized via the first speech recognition as a comparison result.

3. The method of claim 1, further comprising:
performing a first speech recognition to the first digital signal by using the first speech recognition model; and
comparing the first post-processing result with the recognition results obtained by performing the first speech recognition to the first digital signal and the second digital signal.

4. The method of claim 1, further comprising:
transmitting the second digital signal to the cloud server;
receiving a second post-processing result generated according to the first digital signal and the second digital signal;
receiving a third speech input, and converting the third speech input into a third digital signal;
performing a first speech recognition to the third digital signal by using the first speech recognition model; and
comparing the second post-processing result with the recognition results obtained by performing the first speech recognition to the first digital signal, the second digital signal and the third digital signal to determine a speech recognition result.

5. A method of speech recognition, comprising the following steps:
receiving a first digital signal generated according to a first speech input;
performing a second speech recognition to the first digital signal by using a second speech recognition model to obtain a recognition result;
performing a post-processing according to the recognition result by using a post-processing model, and obtaining a first post-processing result; and
outputting the first post-processing result.

6. The method of claim 5, further comprising:
receiving a second digital signal generated according to a second speech input;
performing a second speech recognition to the second digital signal by using the second speech recognition model;
performing a post-processing according to the recognition results obtained by performing the second speech recognition to the first digital signal and the second digital signal by using the post-processing model, and obtaining a second post-processing result; and
outputting the second post-processing result.

7. A speech recognition device, comprising:
at least one memory storing computer-readable instructions; and
at least one processor that executes the instructions to provide:
a speech conversion module configured to receive a speech input, and convert the received speech input into a corresponding digital signal;
a communication module configured to transmit the digital signal to a cloud server and receive a post-processing result generated according to the digital signal;
a speech recognition module configured to perform a first speech recognition according to the digital signal to obtain a recognition result; and
a determining module configured to compare the post-processing result with the recognition result to generate a comparison result.

8. The device of claim 7, wherein the post-processing result comprises a plurality of possible post-processing results, and the determining module is configured to compare the recognition result with the plurality of possible post-processing results, and determine one post-processing result in the plurality of possible post-processing results which is most similar to the recognition result as the comparison result.

9. The device of claim 7, wherein the speech recognition module is configured to perform the first speech recognition to a first digital signal and a second digital signal with a preset time interval; and the determining module is configured to compare the post-processing result generated according to the first digital signal with the recognition results obtained by performing the first speech recognition to the first digital signal and the second digital signal to generate the comparison result.

10. A speech recognition device, comprising:
at least one memory storing computer-readable instructions; and
at least one processor that executes the instructions to provide:
a communication module configured to receive a corresponding digital signal converted according to a received speech input;
a speech recognition module configured to perform a second speech recognition to the digital signal by using a second speech recognition model to obtain a recognition result; and
a post-processing module configured to perform a post-processing according to the recognition result by using a post-processing model, and obtain a post-processing result, wherein the communication module is further configured to output the post-processing result.

11. The device of claim 10, wherein the speech recognition module is configured to perform the second speech recognition to a first digital signal and a second digital signal with a preset time interval; and the post-processing module is configured to perform a post-processing according to the recognition results obtained by performing the second speech recognition to the first digital signal and the second digital signal by using the post-processing model, and obtain a second post-processing result.
